(19) United States
(12) Patent Application Publication
(10) Pub. No.: US 2025/0341756 A1
(43) Pub. Date: Nov. 6, 2025

(54) OPTICAL SYSTEM, LENS APPARATUS, AND IMAGE PICKUP APPARATUS

(71) Applicant: CANON KABUSHIKI KAISHA, Tokyo (JP)

(72) Inventor: KENTO TSUCHIYA, Tochigi (JP)

(21) Appl. No.: 19/192,885

(22) Filed: Apr. 29, 2025

(30) Foreign Application Priority Data
May 1, 2024 (JP) 2024-074224

(51) Int. Cl. G03B 5/06; G03B 17/14; H04N 23/68

(52) U.S. Cl. CPC G03B 5/06; G03B 17/14; H04N 23/683; H04N 23/687; G03B 2205/0023

(57) ABSTRACT

An optical system for use with an image pickup apparatus configured to perform an image stabilizing operation by moving an image sensor configured to image an object or by moving a cut-out area in an image generated using a signal from the image sensor includes an image stabilizing lens unit rotatable so as to tilt relative to an optical axis of the optical system, and at least one negative lens.

### BACKGROUND

### Technical Field

The aspect of the embodiments relates to an optical system, a lens apparatus, and an image pickup apparatus.

### Description of Related Art

During imaging, image blur caused by camera shake or the like is reduced (corrected) by moving (shifting) part of an optical system or an image sensor relative to an optical axis, or by moving a cut-out area from a generated image. However, even if image blurs can be sufficiently corrected in the central area of an image, image blurs may be left uncorrected or overcorrected in the peripheral area of the image.

Japanese Patent Laid-Open No. 2022-149033 discloses a method of correcting image blurs in both the central area and the peripheral area of an image by shifting both part of the optical system and the image sensor relative to the optical axis.

### SUMMARY

One aspect of the embodiments provides an optical system for use with an image pickup apparatus configured to perform an image stabilizing operation by moving an image sensor configured to image an object or by moving a cut-out area in an image generated using a signal from the image sensor. The optical system includes an image stabilizing lens unit rotatable so as to tilt relative to an optical axis of the optical system, and at least one negative lens. A lens apparatus and an image pickup apparatus each having the above optical system also constitute another aspect of the embodiments.

Further features of various embodiments of the disclosure will become apparent from the following description of embodiments with reference to the attached drawings.

### BRIEF DESCRIPTION OF THE DRAWINGS

FIG. 1 illustrates a sectional view of an optical system according to Example 1.

FIG. 2 illustrates a longitudinal aberration diagram of the optical system according to Example 1.

FIG. 3 illustrates a lateral aberration diagram of the optical system according to Example 1.

FIG. 4 illustrates a lateral aberration diagram of the optical system according to Example 1 during image stabilization.

FIG. 5 illustrates a sectional view of an optical system according to Example 2.

FIG. 6 illustrates a longitudinal aberration diagram of the optical system according to Example 2.

FIG. 7 illustrates a lateral aberration diagram of the optical system according to Example 2.

FIG. 8 illustrates a lateral aberration diagram of the optical system according to Example 2 during image stabilization.

FIG. 9 illustrates a sectional view of an optical system according to Example 3.

FIG. 10 illustrates a longitudinal aberration diagram of the optical system according to Example 3.

FIG. 11 illustrates a lateral aberration diagram of the optical system according to Example 3.

FIG. 12 illustrates a lateral aberration diagram of the optical system according to Example 3 during image stabilization.

FIG. 13 is a sectional view of an optical system according to Example 4.

FIG. 14 is a longitudinal aberration diagram of the optical system according to Example 4.

FIG. 15 is a lateral aberration diagram of the optical system according to Example 4.

FIG. 16 is a lateral aberration diagram of the optical system according to Example 4 during image stabilization.

FIG. 17 is a sectional view of an optical system according to Example 5.

FIG. 18 is a longitudinal aberration diagram of the optical system according to Example 5.

FIG. 19 is a lateral aberration diagram of the optical system according to Example 5.

FIG. 20 is a lateral aberration diagram of the optical system according to Example 5 during image stabilization.

FIG. 21 is a sectional view of an optical system according to Example 6.

FIG. 22 is a longitudinal aberration diagram of the optical system according to Example 6.

FIG. 23 is a lateral aberration diagram of the optical system according to Example 6.

FIG. 24 is a lateral aberration diagram of the optical system according to Example 6 during image stabilization.

FIG. 25 is a sectional view of an optical system according to Example 7.

FIG. 26 is a longitudinal aberration diagram of the optical system according to Example 7.

FIG. 27 is a lateral aberration diagram of the optical system according to Example 7.

FIG. 28 is a lateral aberration diagram of the optical system according to Example 7 during image stabilization.

FIG. 29 illustrates image point movement due to rotational shake around the Y-axis.

FIG. 30 illustrates image point movement during lens shift.

FIG. 31 illustrates image point movement during lens tilt.

FIG. 32 illustrates image point movement during sensor shift.

FIG. 33 is a schematic view of a lens apparatus having any one of the optical systems according to Examples 1 to 7.

FIG. 34 is a schematic view of an image pickup apparatus having any one of the optical systems according to Examples 1 to 7.

### DETAILED DESCRIPTION

Referring now to the accompanying drawings, a description will be given of examples according to the present disclosure.

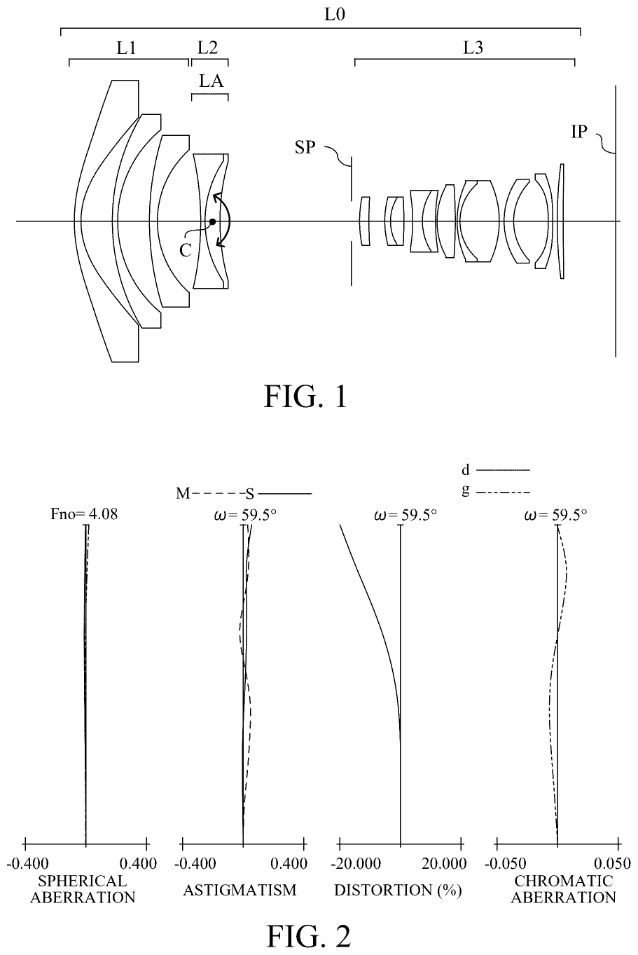

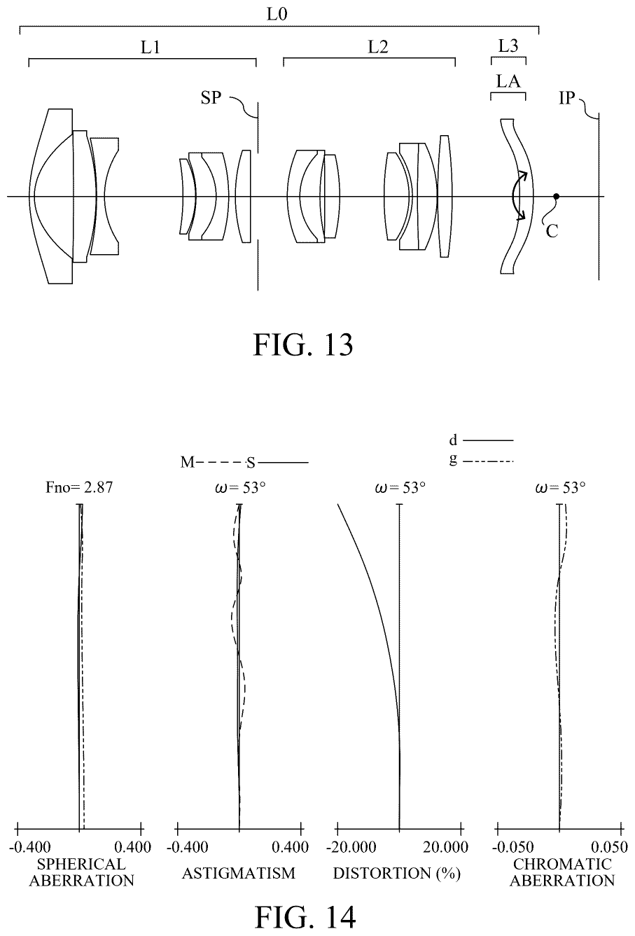

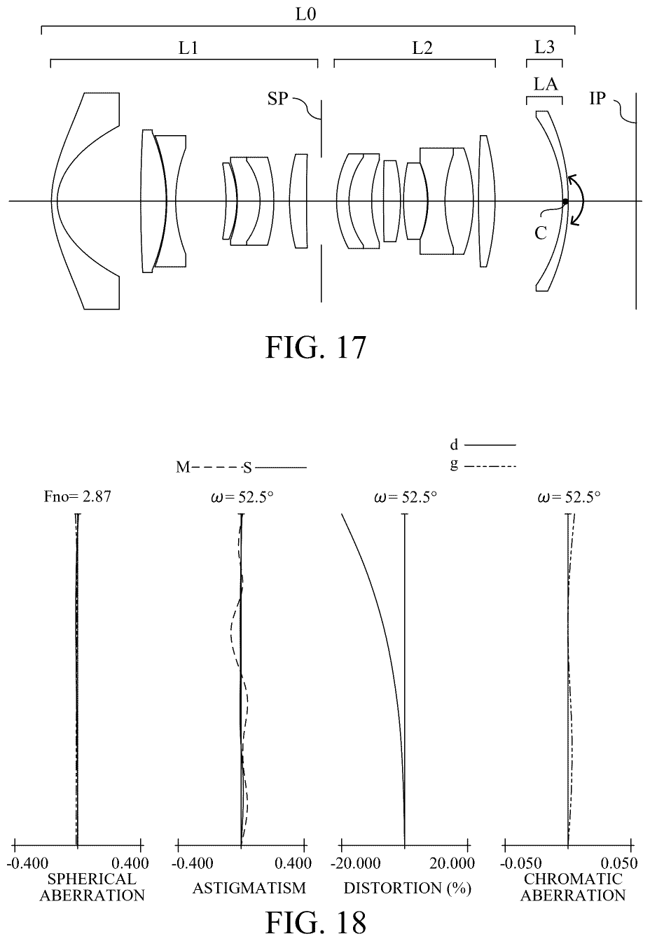

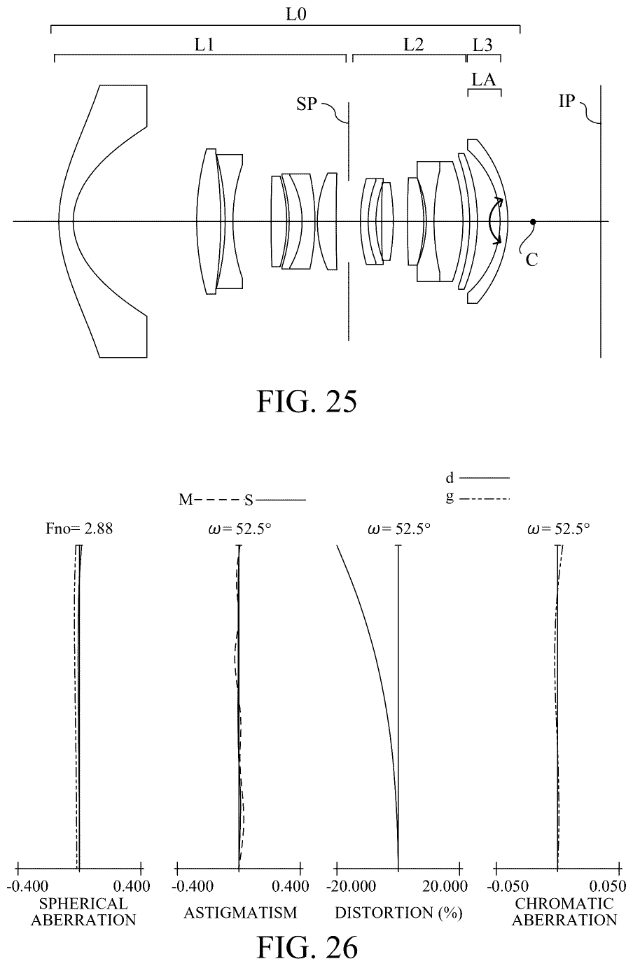

FIGS. 1, 5, 9, 13, 17, 21, and 25 illustrate sections of optical systems L0 according to Examples 1 to 7, respectively, in a state where the optical system is focused on an object at infinity (referred to as “in an in-focus state at infinity” hereinafter). The optical system L0 according to each example is used in various image pickup apparatuses such as digital video cameras, digital still cameras, film-based cameras, broadcasting cameras, and surveillance cameras.

In each figure, a left side is an object side and a right side is an image side. The optical system L0 according to each example includes a plurality of lens units Li (where i is the order counted from the object side) and an aperture stop SP. In each example, the lens unit is a group of one or more lenses that are separated before and after the aperture stop SP, or a group of one or more lenses that may or may not move together (tilt or shift) during image stabilization. The lens unit may include the aperture stop SP. IP represents an image plane. An image sensor (photoelectric conversion element) such as a CCD sensor or CMOS sensor is disposed on the image plane IP.

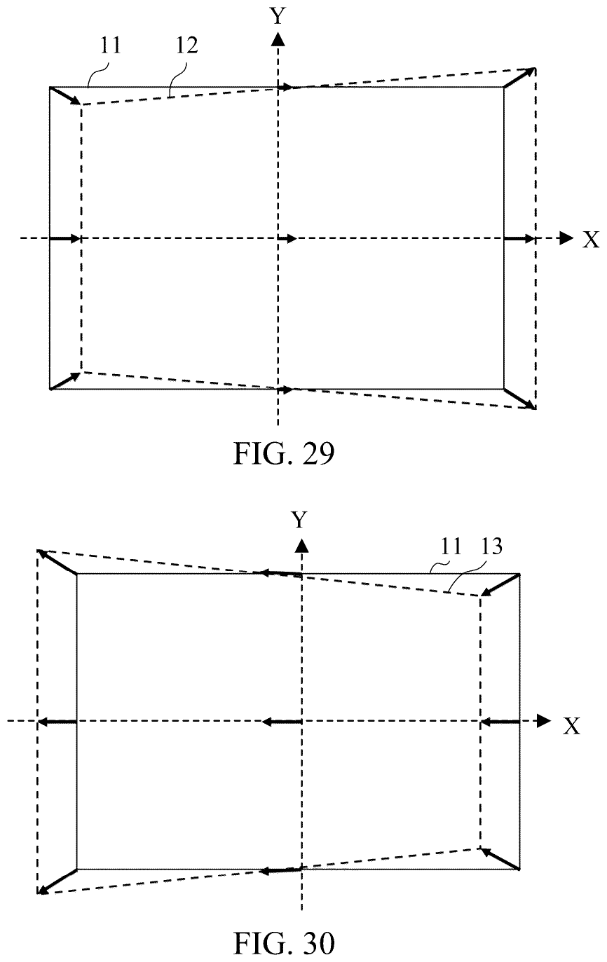

FIG. 29 illustrates the movement of image points on the image plane IP when rotational shake around the Y-axis occurs as a camera shake. The Y-axis in the figure is an axis that passes through the center of the imaging surface and is parallel to the short side of the imaging surface, and the X-axis is an axis that passes through the center of the imaging surface and is parallel to the long side of the imaging surface.

As illustrated in this figure, image shake caused by rotational shake around the Y-axis distorts an original rectangular object image 11 before image shake into a trapezoidal object image 12. In optically correcting distortion in a wide-angle optical system using the central projection method as in the optical system L0 in each example, image shake caused by rotational shake results in large trapezoidal distortion, as in the object image 12. Image shake occurs when each image point on the imaging surface moves according to the image point movement vector indicated by an arrow in FIG. 29. At the center of the imaging surface, image shake occurs in the X-axis direction.

FIGS. 30, 31, and 32 illustrate image point movements after image stabilization is performed by shifting the lens unit included in the optical system in a direction orthogonal to the optical axis (lens shift), tilting the lens unit relative to the optical axis (lens tilt), and shifting the image sensor in a direction orthogonal to the optical axis (sensor shift), respectively. All of these figures illustrate the image point movement after image stabilization is performed to satisfactorily correct the image blur at the center of the imaging surface illustrated in FIG. 29.

When the lens shift is performed as illustrated in FIG. 30, image point movement occurs on each of the Y-axis and at the peripheral image heights of the four corners, with at least one of a moving direction and a moving amount different from the image point movement at the center of the imaging surface and at the peripheral image heights on the X-axis. As a result, the rectangular object image 11 is distorted into a trapezoidal object image 13.

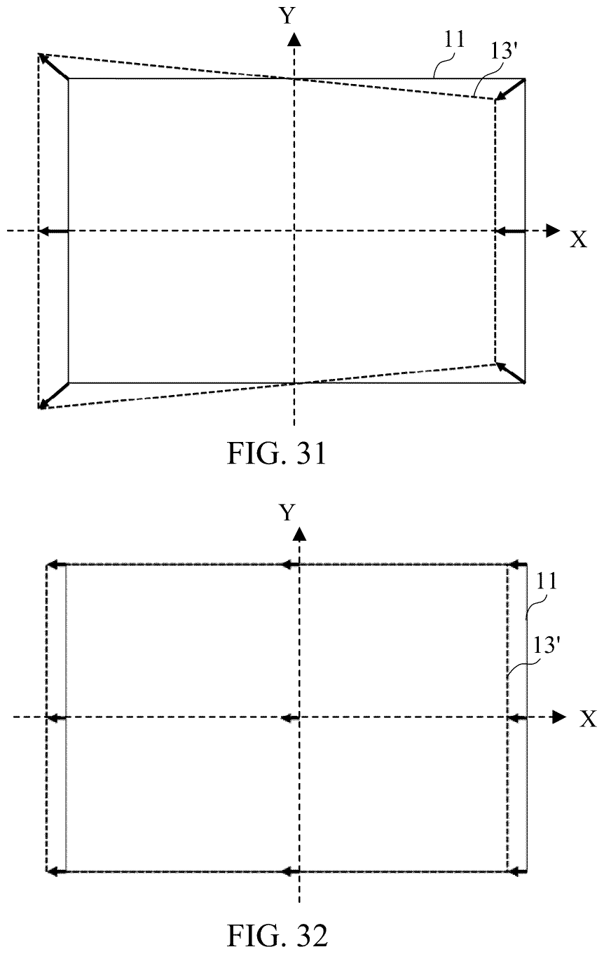

When the lens tilt is performed as illustrated in FIG. 31, no image point movement occurs on the Y-axis, and image point movement occurs on the X-axis and at the peripheral image heights of the four corners, with at least one of the moving direction and moving amount different. As a result, the rectangular object image 11 is distorted into a trapezoidal object image 13′.

When the sensor shift is performed as illustrated in FIG. 32, uniform image point movement (with the same moving direction and moving amount) occurs at the center of the imaging surface, on the X-axis, on the Y-axis, and at all peripheral image heights at the four corners. As a result, the rectangular object image 11 changes to an object image 13″ that has been translated in parallel.

In the optical system L0 according to each example, in a case where the image pickup apparatus performs a sensor shift as an image stabilizing operation to correct image blur in the central and peripheral areas, the optical system L0 performs the lens tilt that is mainly suitable for image stabilization in the peripheral area. This lens tilt can suppress insufficient correction or overcorrection that tends to occur in the peripheral area with only the sensor shift, and can satisfactorily correct image blur in both the central and peripheral areas. Instead of the sensor shift, the image pickup apparatus may perform image processing as an image stabilizing operation to move (shift) a cut-out area from an image generated by a signal from the image sensor.

A description will now be given of a characteristic configuration of the optical system L0 according to each example. The optical system L0 according to each example includes an image stabilizing lens unit LA configured to rotate (tilt) so as to be tilted relative to the optical axis of the optical system L0 (or a plane orthogonal to the optical axis), assuming that the optical system L0 is used in an image pickup apparatus that performs sensor shift or image processing as an image stabilizing operation. More specifically, the image stabilizing lens unit LA rotates around a point on or near the optical axis. Tilting the image stabilizing lens unit LA together with the image stabilizing operation of the image pickup apparatus can effectively correct image blur not only in the central area but also in the peripheral area, as described above.

The image stabilizing lens unit LA may include one single lens or one cemented lens. This is convenient for an actuator configured to tilt the image stabilizing lens unit LA, because the size and weight of the image stabilizing lens unit LA can be reduced, and a size increase in the actuator can be suppressed.

A plurality of image stabilizing lens units LA may be provided in the optical system L0.

The optical system L0 according to each example may satisfy at least one of the following inequalities (1) to (7). In inequalities (1) to (7), fis is a focal length of the image stabilizing lens unit LA, fis a focal length of the optical system L0, and tis is a distance from the aperture stop SP to a lens surface closest to the aperture stop in the image stabilizing lens unit LA. dis is a distance on the optical axis from a lens surface closest to the object in the image stabilizing lens unit LA to a rotation center of the image stabilizing lens unit LA. Da is a length from a lens surface closest to the object in the image stabilizing lens unit LA to a lens surface closest to the image plane in the image stabilizing lens unit LA, and D is a length on the optical axis from a lens surface closest to the object in the optical system L0 to the image plane IP. Dbf is a length on the optical axis from a lens surface closest to the image plane in the optical system L0 to the image plane IP. ymax is a maximum image height of the optical system L0.

$$\begin{matrix}8.45 \leq \vert fis \vert / f \leq 30.00 & ( 1 ) \\ 1.3 \leq \vert tis \vert / f \leq 6.0 & ( 2 ) \\ 0 < \vert dis \vert / f \leq 0.51 & ( 3 ) \\ 0 < Da / D \leq 0.06 & ( 4 ) \\ 0.75 \leq Dbf / f \leq 1.30 & ( 5 ) \\ 0 < Da / \vert fis \vert \leq 0.03 & ( 6 ) \\ 0.8 \leq ymax / f \leq 1.8 & ( 7 )\end{matrix}$$

Inequality (1) defines a proper relationship between the focal length fis of the image stabilizing lens unit LA and the focal length f of the optical system L0. In a case where the focal length fis of the image stabilizing lens unit LA increases (refractive power decreases) so that |fis|/f becomes higher than the upper limit of inequality (1), the image stabilizing effect in the peripheral area on the tilt component and shift component due to the tilt of the image stabilizing lens unit LA is reduced. As a result, the tilt angle of the image stabilizing lens unit LA required for good image stabilization in the peripheral area increases, and decentering aberration such as decentering coma and image plane tilt increases. In a case where the focal length fis of the image stabilizing lens unit LA decreases (refractive power increases) so that |fis|/f becomes lower than the lower limit of inequality (1), overcorrection of image blur occurs in the peripheral area, and high image stabilizing performance cannot be obtained.

Inequality (2) defines a proper relationship between the distance tis from the aperture stop SP to the image stabilizing lens unit LA and the focal length f of the optical system L0. In a case where the image stabilizing lens unit LA moves away from the aperture stop SP so that |tis|/f becomes higher than the upper limit of inequality (2), the size and weight of the image stabilizing lens unit LA increase, and it becomes difficult to drive the image stabilizing lens unit LA. In a case where the image stabilizing lens unit LA approaches the aperture stop SP so that |tis|/f becomes lower than the lower limit of inequality (2), the position at which the off-axis light beam is refracted in the image stabilizing lens unit LA becomes lower, and it becomes difficult to adjust the distortion.

Inequality (3) defines a proper relationship between the distance dis from the lens surface closest to the object in the image stabilizing lens unit LA to the rotation center and the focal length f of the optical system L0. In a case where the distance dis increases so that |dis|/f becomes higher than the upper limit of inequality (3), the ratio of the shift component in the tilt of the image stabilizing lens unit LA increases. As a result, overcorrection of image blur occurs in the peripheral area, and high image stabilizing performance in the peripheral area cannot be obtained.

However, the image stabilizing lens unit LA may be shifted in a direction orthogonal to the optical axis, with or without tilting. The rotation center for tilting the image stabilizing lens unit LA may be moved (adjusted).

Inequality (4) defines a proper relationship between the thickness Da of the image stabilizing lens unit LA and the overall optical length D of the optical system L0. In a case where the thickness Da of the image stabilizing lens unit LA increases so that Da/D becomes higher than the upper limit of inequality (4), the size of the structure for tilting the image stabilizing lens unit LA increases.

Inequality (5) defines a proper relationship between the back focus Dbf of the optical system L0 and the focal length f of the optical system L0. In a case where the back focus Dbf increases so that Dbf/f becomes higher than the upper limit of inequality (5), it becomes difficult to reduce the overall optical length of the optical system L0 (reducing the size of the optical system L0). In a case where the back focus Dbf decreases so that Dbf/f becomes lower than the lower limit of inequality (5), and it becomes difficult to mechanically connect the lens apparatus including the optical system L0 to the image pickup apparatus.

Inequality (6) defines a proper relationship between the thickness Da of the image stabilizing lens unit LA and the focal length fis of the image stabilizing lens unit LA. In a case where the focal length fis of the image stabilizing lens unit LA decreases so that Da/|fis| becomes higher than the upper limit of inequality (6), overcorrection occurs in the peripheral area, and high image stabilizing performance in the peripheral area cannot be obtained.

Inequality (7) defines a proper relationship between the maximum image height ymax of the optical system L0 and the focal length f of the optical system L0. In a case where the maximum image height ymax increases so that ymax/f becomes higher than the upper limit of inequality (7), light rays from a field angle wider than the required field angle are imaged on the imaging surface, and the sizes of the optical system L0 and the image pickup apparatus increase. In a case where ymax decreases, only light rays from an angle of view narrower than the required angle of view are imaged on the imaging surface.

Inequalities (1) to (7) may be replaced with inequalities (la) to (7a) below:

$$\begin{matrix}8.50 \leq \vert fis \vert / f \leq 28.00 & ( 1 a ) \\ 1.35 \leq \vert tis \vert / f \leq 5.50 & ( 2 a ) \\ 0.010 \leq \vert dis \vert / f \leq 0.508 & ( 3 a ) \\ 0.002 \leq Da / D \leq 0.055 & ( 4 a ) \\ 0.78 \leq Dbf / f \leq 1.27 & ( 5 a ) \\ 0.003 \leq Da / \vert fis \vert \leq 0.028 & ( 6 a ) \\ 0.82 \leq ymax / f \leq 1.78 & ( 7 a )\end{matrix}$$

Inequalities (1) to (7) may be replaced with inequalities (1b) to (7b) below:

$$\begin{matrix}8.60 \leq \vert fis \vert / f \leq 25.00 & ( 1 b ) \\ 1.4 \leq \vert tis \vert / f \leq 5.0 & ( 2 b ) \\ 0.020 \leq \vert dis \vert / f \leq 0.505 & ( 3 b ) \\ 0.003 \leq Da / D \leq 0.050 & ( 4 b ) \\ 0.80 \leq Dbf / f \leq 1.25 & ( 5 b ) \\ 0.005 \leq Da / \vert fis \vert \leq 0.026 & ( 6 b ) \\ 0.84 \leq ymax / f \leq 1.75 & ( 7 b )\end{matrix}$$

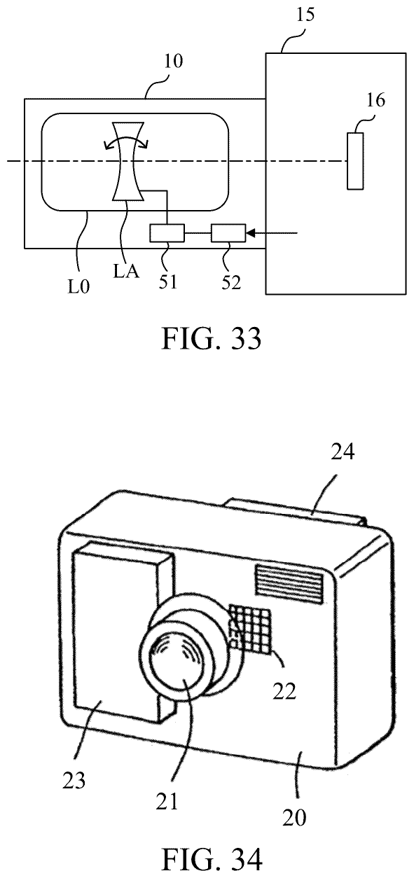

FIG. 33 illustrates a lens apparatus 10 having the optical system L0 according to each example and an image pickup apparatus 15 to which the lens apparatus 10 is detachably attached. The lens apparatus 10 includes an actuator 51 configured to tilt the image stabilizing lens unit LA, and a control unit 52 configured to control the actuator. The image pickup apparatus 15 includes an image sensor 16.

For example, the control unit 52 of the lens apparatus 10 controls the actuator 51 to tilt the image stabilizing lens unit LA according to a command from the image pickup apparatus 15 when the image pickup apparatus 15 performs the image stabilizing operation. The command from the image pickup apparatus 15 to the control unit 52 includes information such as a tilt amount of the image stabilizing lens unit LA calculated based on a parameter of the image stabilizing operation performed by the image pickup apparatus 15 (such as a sensor shift amount and a shift amount of a cut-out area). The control unit 52 may also obtain parameters of the image stabilizing operation performed by the image pickup apparatus 15 from the image pickup apparatus 15 to calculate the tilt amount of the image stabilizing lens unit LA, and control the actuator 51 based on the calculation result.

The lens apparatus may include a memory that stores distortion correction data for correcting distortion of an image generated in the image pickup apparatus using a signal from the image sensor. The distortion correction data is data corresponding to each optical system L0. The image pickup apparatus can correct distortion of an image by image processing using the distortion correction data acquired from the lens apparatus. The image pickup apparatus may acquire distortion correction data from another server (including a server on the cloud) via a network. This allows aberrations other than distortion to be suppressed in the optical system L0, while distortion can be corrected by image processing.

The image pickup apparatus that integrally or detachably includes the optical system L0 according to each example may control the tilt drive of the image stabilizing lens unit LA in an image stabilizing operation.

Next, the optical systems L0 according to Examples 1 to 7 will be specifically described.

The optical system L0 according to Example 1 illustrated in FIG. 1 includes, in order from the object side to the image side, a first lens unit L1, a second lens unit L2, an aperture stop SP, and a third lens unit L3. The second lens unit L2 as an image stabilizing lens unit LA can be tilted around a point C on or near the optical axis.

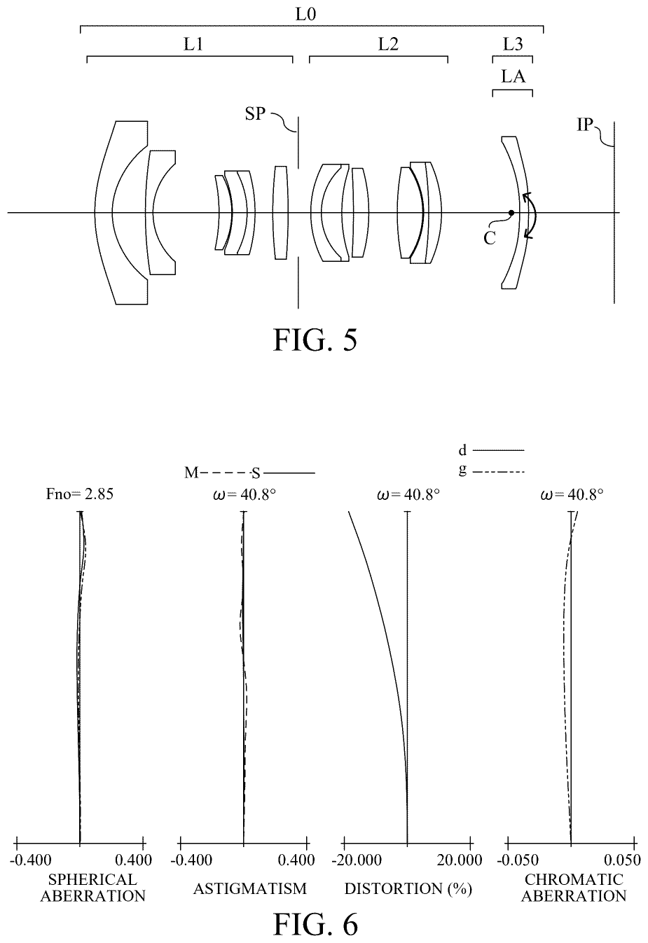

Each of the optical systems L0 according to Examples 2, 4, 5, and 7 illustrated in FIGS. 5, 13, 17, and 25, respectively, includes, in order from the object side to the image side, a first lens unit L1, an aperture stop SP, a second lens unit L2, and a third lens unit L3. The third lens unit L3 as the image stabilizing lens unit LA can be tilted around a point C on or near the optical axis.

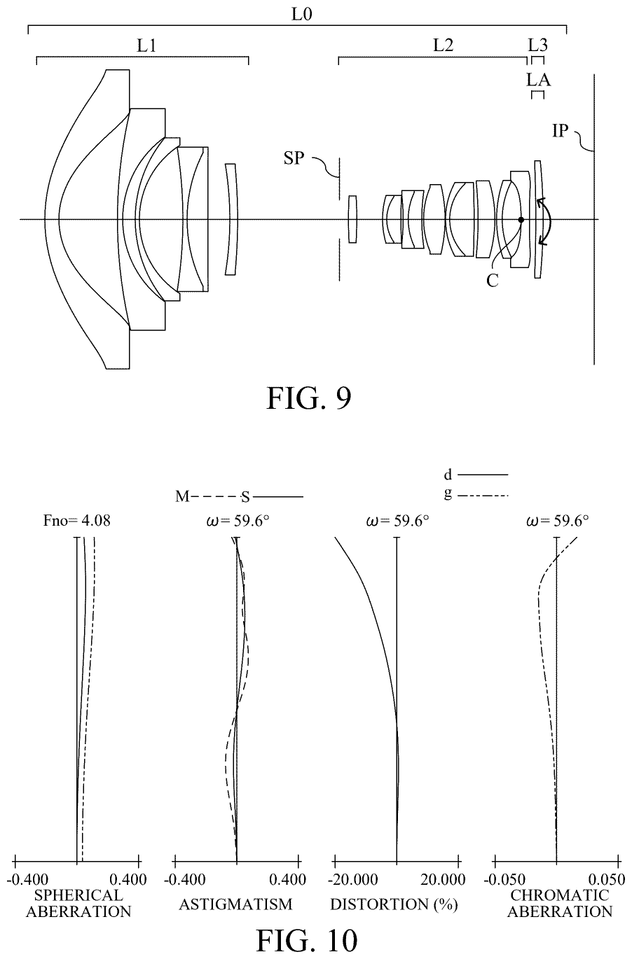

The optical system L0 according to Example 3 illustrated in FIG. 9 includes, in order from the object side to the image side, a first lens unit L1, a second lens unit L2 including an aperture stop SP closest to the object, and a third lens unit L3. The third lens unit L3 as the image stabilizing lens unit LA can tilt around a point C on or near the optical axis.

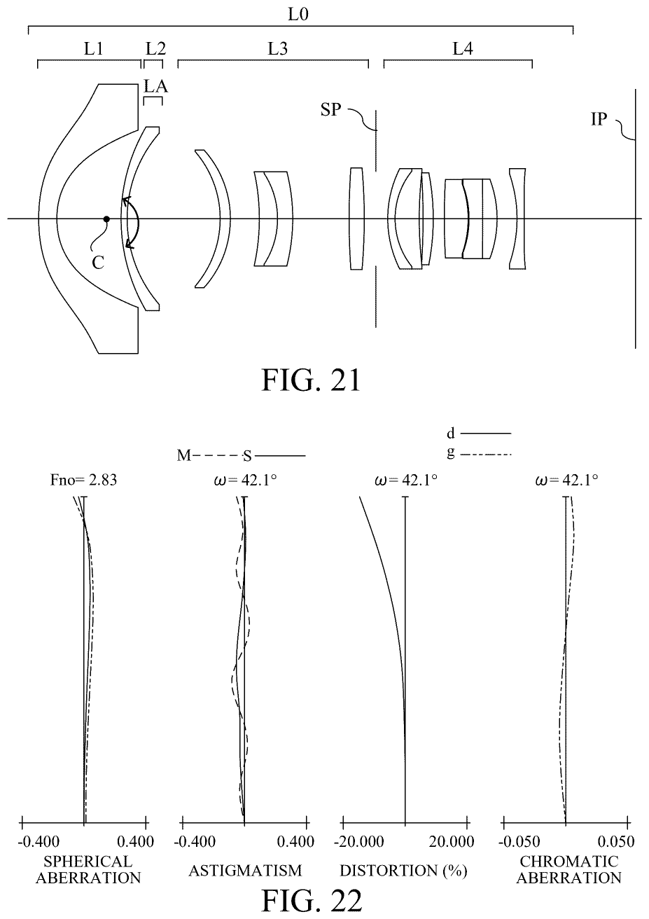

The optical system L0 according to Example 6 illustrated in FIG. 21 includes, in order from the object side to the image side, a first lens unit L1, a first lens unit L1, a second lens unit L2, a third lens unit L3, an aperture stop SP, and a fourth lens unit L4. The second lens unit L2 as the image stabilizing lens unit LA can tilt around a point C on or near the optical axis.

The numerical values corresponding to Examples 1 to 7 will be illustrated below. In surface data of each numerical example, a surface number m indicates the order of the surface counted from the object side, r (mm) represents a radius of curvature of an m-th surface, and d (mm) represents a distance on the optical axis between m-th and (m+1)-th surfaces (surface distance). nd is a refractive index for the d-line (with a wavelength 587.56 nm) of the optical material between m-th and (m+1)-th surfaces, and νd is an Abbe number of the optical member based on the d-line. The Abbe number νd based on the d-line is expressed as follows:

$$vd = ( Nd - 1 ) / ( NF - NC )$$

where Nd, NF, and NC are refractive indices for the d-line, F-line (with a wavelength 486.13 nm), and C-line (with a wavelength 656.27 nm), respectively. The effective diameter is a radius (mm) of an area of the m-th surface through which light rays that contribute to imaging pass.

The surface distance d (mm), focal length (mm) in each data, F-number, and half angle of view (*) calculated by paraxial calculation are all values in the in-focus state at infinity.

The back focus BF (Dbf in inequality (5)) is a distance on the optical axis from the lens surface closest to the image plane (final surface) in the optical system to the paraxial image plane, expressed in air-equivalent length. The overall lens length (overall optical length D in inequality (4)) is a distance on the optical axis from the lens surface closest to the object (frontmost surface) in the optical system to the final surface plus the back focus BF.

An asterisk “*” next to a surface number means that the surface has an aspheric shape. The aspheric shape is expressed by the following equation:

$$x = ( {h}^{2} / R ) / {[ 1 + \{ 1 - ( 1 + K ) {( h / R )}^{2} \} ]}^{1 / 2} + A 4 \times {h}^{4} + A 6 \times {h}^{6} + A 8 \times {h}^{8} + A 10 \times {h}^{10} + A 12 \times {h}^{12} + A 14 \times {h}^{14}$$

where x is a displacement amount from a surface vertex in the optical axis direction, h is a height from the optical axis in a direction orthogonal to the optical axis, the light traveling direction is positive, R is a paraxial radius of curvature, K is a conic constant, and A4, A6, A8, A10, A12, and A14 are aspheric coefficients. “e±XX” in the conic constant and aspheric coefficients means “×10^{±XX}”.

Various data on the image stabilizing lens unit LA in the in-focus state at infinity is illustrated as image stabilizing lens unit data. The tilt component indicates the tilt angle relative to the optical axis of the image stabilizing lens unit LA in correcting image shake at a correction angle of 0.4° (a state in which the optical system L0 is tilted by 0.4° relative to the front principal point on the optical axis). The rotation center indicates a distance on the optical axis from the lens surface closest to the object of the image stabilizing lens unit LA to the rotation center (dis in inequality (3)). The sensor shift amount indicates a shift amount of the image sensor relative to the tilt angle of the image stabilizing lens unit LA.

FIGS. 2, 6, 10, 14, 18, 22, and 26 respectively illustrate the longitudinal aberrations (spherical aberration, astigmatism, distortion, and chromatic aberration) of the optical system L0 according to numerical examples 1 to 7. In the spherical aberration diagram, Fno represents an F-number. A solid line indicates a spherical aberration amount for the d-line, and an alternate long and two short dashes line indicates a spherical aberration amount for the g-line (with a wavelength 435.8 nm). In the astigmatism diagram, a solid line S indicates an astigmatism amount on the sagittal image plane, and a dashed line M indicates an astigmatism amount on the meridional image plane. The distortion diagram illustrates a distortion amount for the d-line. The chromatic aberration diagram illustrates a lateral chromatic aberration amount for the g-line. ω is a half angle of view (°) based on paraxial calculations.

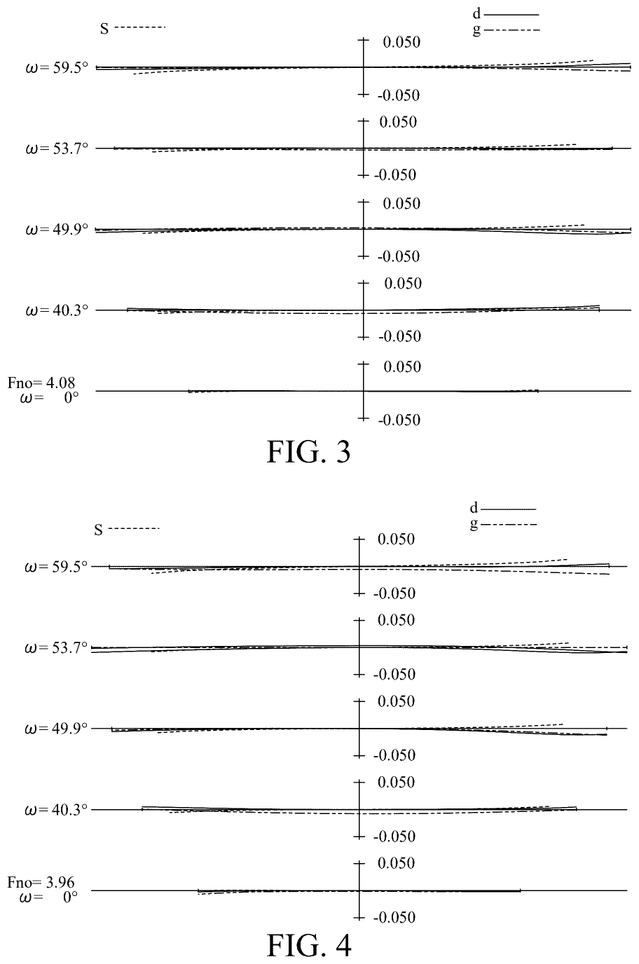

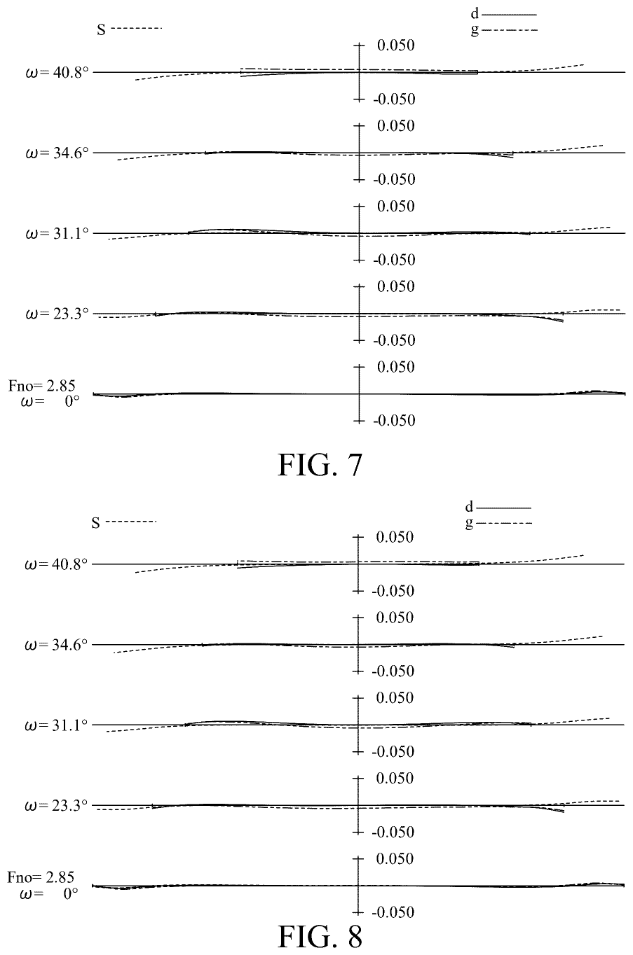

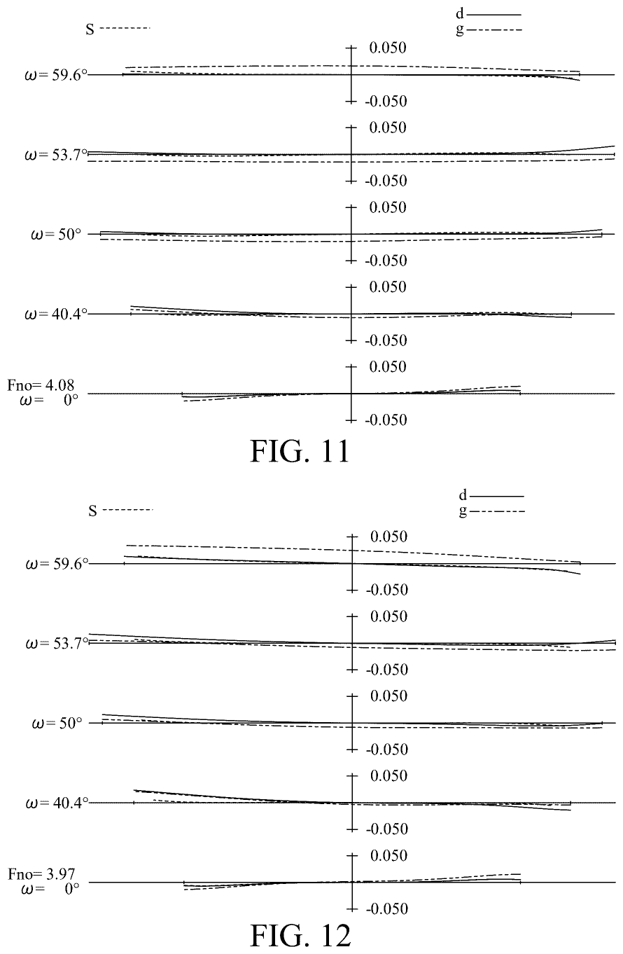

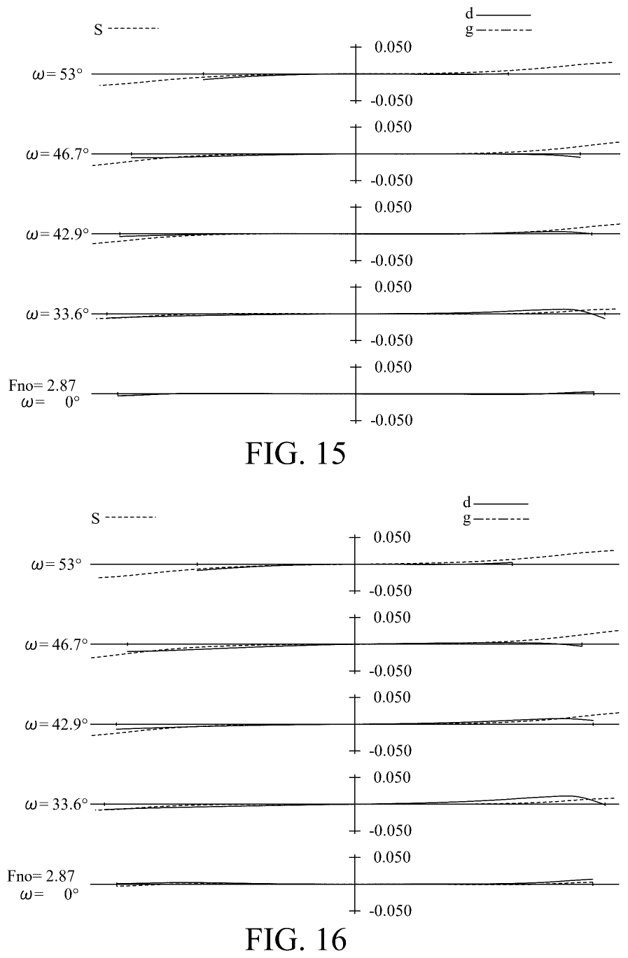

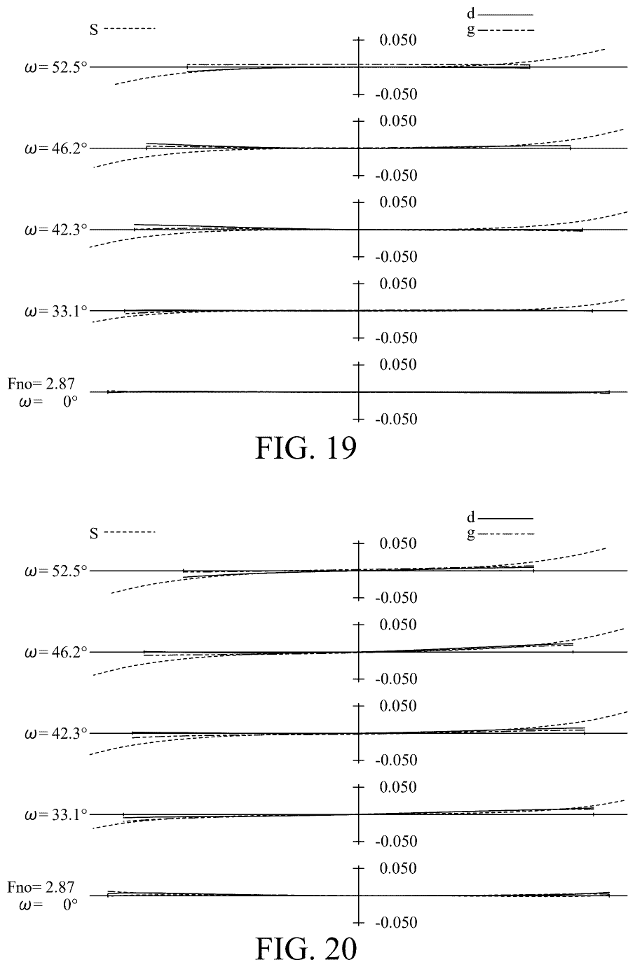

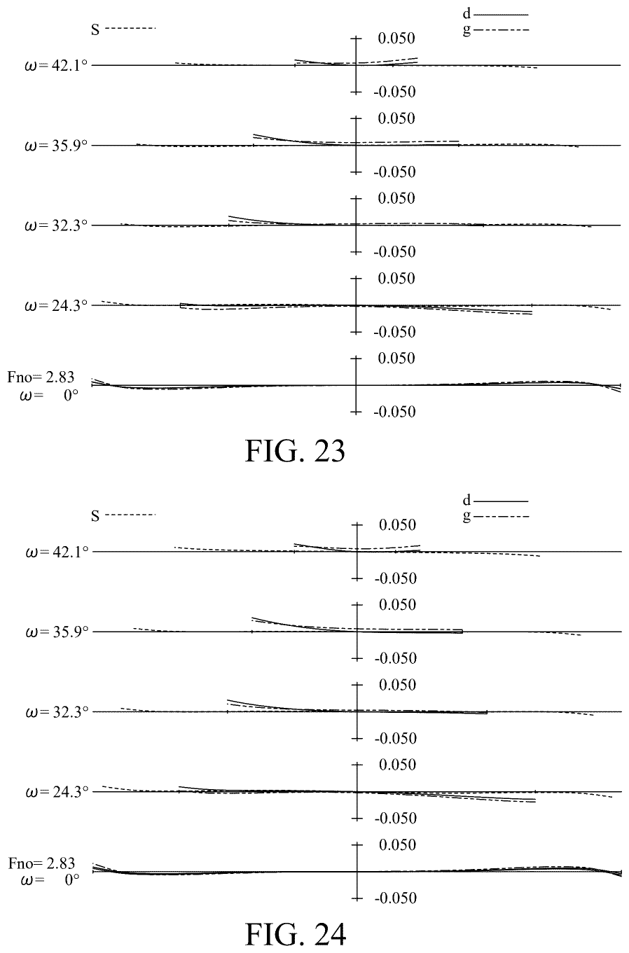

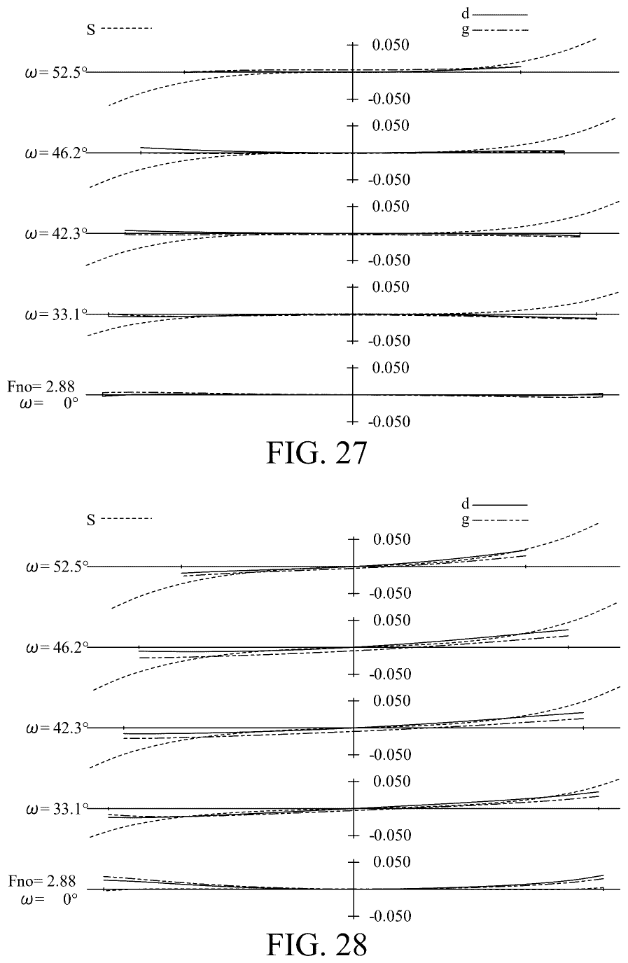

FIGS. 3, 7, 11, 15, 19, 23, and 27 respectively illustrate the lateral aberrations of optical systems L0 according to numerical examples 1 to 7. FIGS. 4, 8, 12, 16, 20, 24, and 28 each illustrate the lateral aberrations during image stabilization (when the image stabilizing lens unit LA is tilted) when each of the optical systems L0 according to numerical examples 1 to 7 is tilted by 0.4° relative to the front principal point on the optical axis. From top to bottom, the aberrations for the d-line and g-line at 100%, 80%, 70%, 50% of the image height and at the center are illustrated. A dashed line illustrates an aberration amount on the sagittal image plane of the d-line, a solid line illustrates an aberration amount on the meridional image plane of the d-line, and an alternate long and two short dashes line illustrates an aberration amount on the meridional image plane for the g-line.

Table 1 summarizes values of inequalities (1) to (7) for the optical system L0 according to numerical examples 1 to 7. The optical system L0 according to each numerical example satisfies all of inequalities (1) to (7).

### Numerical Example 1

UNIT: mm
SURFACE DATA

| Surface No. | r | d | nd | νd | Effective Diameter |
|---|---|---|---|---|---|
| 1* | 36.479 | 1.51 | 1.58313 | 59.4 | 61.65 |
| 2* | 17.975 | 7.18 | | | 47.14 |
| 3 | 46.795 | 1.22 | 1.65160 | 58.5 | 46.59 |
| 4 | 26.752 | 7.28 | | | 39.59 |
| 5 | 65.135 | 1.82 | 1.49700 | 81.5 | 37.47 |
| 6 | 21.676 | 9.93 | | | 30.71 |
| 7 | −68.164 | 1.00 | 1.43875 | 94.7 | 28.83 |
| 8 | 24.432 | 3.41 | 1.88300 | 40.8 | 26.00 |
| 9 | 49.826 | 30.09 | | | 25.19 |
| 10 (SP) | ∞ | 1.88 | | | 9.19 |
| 11 | 27.174 | 2.14 | 1.51633 | 64.1 | 9.53 |
| 12 | 93.993 | 3.63 | | | 9.48 |
| 13 | 20.942 | 1.31 | 1.92119 | 24.0 | 9.55 |
| 14 | 10.172 | 3.07 | 1.65412 | 39.7 | 9.15 |
| 15 | −105.385 | 2.03 | | | 9.55 |
| 16 | −35.066 | 2.21 | 1.88300 | 40.8 | 10.46 |
| 17 | 12.538 | 3.00 | 1.92286 | 20.9 | 12.21 |
| 18 | 41.587 | 0.35 | | | 12.94 |
| 19 | 16.726 | 4.20 | 1.49700 | 81.5 | 14.90 |
| 20* | −81.963 | 0.41 | | | 15.51 |
| 21 | 20.693 | 0.65 | 2.00100 | 29.1 | 16.40 |
| 22 | 11.132 | 9.00 | 1.49700 | 81.5 | 15.83 |
| 23 | −21.399 | 1.10 | | | 17.24 |
| 24 | 16.899 | 2.18 | 1.64850 | 53.0 | 17.88 |
| 25 | 12.797 | 7.94 | | | 16.77 |
| 26* | −34.500 | 1.02 | 1.85338 | 40.4 | 17.85 |
| 27* | −111.072 | 1.03 | | | 19.91 |
| 28 | 101.481 | 1.39 | 1.49700 | 81.5 | 23.99 |
| 29 | 794.992 | 12.04 | | | 24.50 |
| Image Plane | ∞ | | | | |

ASPHERIC DATA
1st Surface
K = 0.00000e+00 A 4 = −5.76276e−06 A 6 = −2.33526e−08
A 8 = 5.19803e−11 A10 = −5.68362e−14 A12 = 3.25920e−17
A14 = −8.43254e−21
2nd Surface
K = −8.75943e−01 A 4 = 3.61147e−06 A 6 = −3.61112e−08
A 8 = −7.92564e−11 A10 = 3.80820e−13 A12 = −4.78121e−16
A14 = 2.03396e−19
20th Surface
K = 0.00000e+00 A 4 = 2.69457e−05 A 6 = 9.62891e−09
A 8 = −3.26028e−09 A10 = 4.51333e−11 A12 = −1.99041e−13
26th Surface
K = 0.00000e+00 A 4 = −1.88665e−04 A 6 = −6.70269e−07
A 8 = 6.85636e−09 A10 = −9.60929e−11 A12 = 8.62772e−13
27th Surface
K = 0.00000e+00 A 4 = −1.27339e−04 A 6 = 4.90803e−08
A 8 = −5.46075e−10 A10 = 3.13522e−11 A12 = −1.68209e−14

VARIOUS DATA

| | |
|---|---|
| Focal Length | 10.19 |
| Fno | 4.08 |
| Half Angle of View (°) | 59.52 |
| Image Height | 17.31 |
| Overall Lens Length | 124.01 |
| BF | 12.04 |

IMAGE STABILIZING LENS UNIT DATA

| Starting Surface No. 7 | End Surface No. 9 | |
|---|---|---|
| Focal Length fis | −178.788 | mm |
| Correction Angle | 0.400° | |
| Tilt Component | 1.416° | |
| Rotation Center | 3.565 | mm |
| Sensor Shift Amount | −0.104 | mm |

### Numerical Example 2

UNIT: mm
SURFACE DATA

| Surface No. | r | d | nd | νd | Effective Diameter |
|---|---|---|---|---|---|
| 1* | 27.962 | 3.40 | 1.60300 | 65.4 | 33.72 |
| 2* | 13.836 | 6.47 | | | 24.37 |
| 3 | 75.664 | 1.49 | 1.43875 | 94.7 | 22.28 |
| 4 | 12.563 | 12.91 | | | 17.80 |
| 5 | −32.360 | 2.49 | 1.65160 | 58.5 | 12.58 |
| 6 | −15.133 | 0.10 | | | 13.22 |
| 7 | −18.124 | 2.88 | 1.59522 | 67.7 | 13.24 |
| 8 | −16.605 | 1.55 | 1.83400 | 37.2 | 14.07 |
| 9 | −29.320 | 3.46 | | | 14.92 |
| 10 | 78.881 | 3.00 | 1.49700 | 81.5 | 16.33 |
| 11 | −114.095 | 1.99 | | | 16.61 |
| 12 (SP) | ∞ | 2.42 | | | 16.86 |
| 13 | 19.796 | 2.07 | 1.90110 | 27.1 | 17.36 |
| 14 | 11.803 | 4.00 | 1.69895 | 30.1 | 16.09 |
| 15 | 26.921 | 2.28 | | | 15.61 |
| 16 | −135.219 | 3.00 | 1.71300 | 53.9 | 15.62 |
| 17 | −31.605 | 5.55 | | | 15.75 |
| 18 | 47.319 | 4.99 | 1.45860 | 90.2 | 15.54 |
| 19 | −15.728 | 0.17 | | | 16.27 |
| 20 | −16.105 | 1.00 | 1.90043 | 37.4 | 16.27 |
| 21 | −68.180 | 2.49 | 1.43875 | 94.7 | 17.63 |
| 22 | −23.231 | 15.26 | | | 18.35 |
| 23* | −46.699 | 1.74 | 1.75500 | 52.3 | 25.51 |
| 24* | −65.393 | 16.75 | | | 27.26 |
| Image Plane | ∞ | | | | |

ASPHERIC DATA
1st Surface
K = −1.21516e+01 A 4 = 4.07720e−05 A 6 = − 2.36233e−07
A 8 = 5.83090e−10 A10 = −2.50162e−13 A12 = −9.08701e−16
2nd Surface
K = −2.04612e+00 A 4 = 4.23647e−05 A 6 = 4.73871e−07
A 8 = −7.14398e−09 A10 = 4.37490e−11 A12 = −8.36011e−14
23rd Surface
K = −1.57755e+01 A 4 = −1.49841e−04 A 6 = 1.20221e−06
A 8 = −8.76814e−09 A10 = 5.10644e−11 A12 = −1.26245e−13
24th Surface
K = 1.06851e+01 A 4 = −9.72895e−05 A 6 = 8.56295e−07
A 8 = −4.81673e−09 A10 = 2.45587e−11 A12 = −5.54178e−14

VARIOUS DATA

| | |
|---|---|
| Focal Length | 20.39 |
| Fno | 2.88 |
| Half Angle of View (°) | 40.80 |
| Image Height | 17.60 |
| Overall Lens Length | 101.46 |
| BF | 16.75 |

IMAGE STABILIZING LENS UNIT DATA

| Starting Surface No. 23 | End Surface No. 24 | |
|---|---|---|
| Focal Length fis | −225.407 | mm |
| Correction Angle | 0.400° | |
| Tilt Component | 0.300° | |
| Rotation Center | −3.518 | mm |
| Sensor Shift Amount | −0.139 | mm |

### Numerical Example 3

UNIT: mm
SURFACE DATA

| Surface No. | r | d | nd | νd | Effective Diameter |
|---|---|---|---|---|---|
| 1* | 37.172 | 3.38 | 1.58313 | 59.4 | 69.28 |
| 2* | 18.253 | 14.08 | | | 50.88 |
| 3 | 112.447 | 1.26 | 1.88300 | 40.8 | 50.57 |
| 4 | 24.158 | 3.02 | | | 37.76 |
| 5 | 30.338 | 1.00 | 1.49700 | 81.5 | 37.33 |
| 6 | 21.017 | 10.48 | | | 33.52 |
| 7 | −107.278 | 1.00 | 1.43875 | 94.7 | 32.80 |
| 8 | 35.086 | 5.00 | 1.88300 | 40.8 | 30.29 |
| 9 | 2395.252 | 5.29 | | | 29.40 |
| 10 | −79.798 | 1.87 | 1.90043 | 37.4 | 24.44 |
| 11 | −138.047 | 24.51 | | | 23.59 |
| 12 (SP) | ∞ | 2.16 | | | 9.33 |
| 13 | 102.813 | 2.00 | 1.60342 | 38.0 | 9.64 |
| 14 | −97.711 | 6.21 | | | 9.72 |
| 15 | 19.935 | 1.01 | 1.80518 | 25.4 | 9.83 |
| 16 | 9.407 | 3.42 | 1.65412 | 39.7 | 9.50 |
| 17 | 105.052 | 0.53 | | | 10.29 |
| 18 | −52.469 | 1.23 | 1.90366 | 31.3 | 10.39 |
| 19 | 15.052 | 3.27 | 1.95906 | 17.5 | 11.56 |
| 20 | 47.155 | 0.43 | | | 12.57 |
| 21 | 19.608 | 5.18 | 1.49700 | 81.5 | 14.24 |
| 22* | −32.288 | 0.11 | | | 15.40 |
| 23 | 18.458 | 1.00 | 2.05090 | 26.9 | 16.45 |
| 24 | 11.709 | 5.87 | 1.49700 | 81.5 | 15.74 |
| 25 | −224.521 | 0.96 | | | 16.27 |
| 26 | −86.871 | 4.05 | 1.49700 | 81.5 | 16.45 |
| 27 | −31.004 | 0.41 | | | 17.20 |
| 28 | 28.028 | 1.35 | 2.00100 | 29.1 | 17.41 |
| 29 | 19.614 | 4.58 | | | 16.87 |
| 30* | −30.751 | 2.00 | 1.85338 | 40.4 | 17.19 |
| 31* | −339.190 | 1.50 | | | 20.96 |
| 32 | −336.248 | 1.77 | 2.00100 | 29.1 | 23.23 |
| 33 | −141.799 | 12.30 | | | 24.29 |
| Image Plane | ∞ | | | | |

ASPHERIC DATA
1st Surface
K = 0.00000e+00 A 4 = 3.74097e−06 A 6 = −2.92679e−08
A 8 = 5.19894e−11 A10 = −5.43293e−14 A12 = 3.15125e−17
A14 = −8.62298e−21
2nd Surface
K = −8.39318e−01 A 4 = 1.20191e−05 A 6 = −3.30108e−08
A 8 = −4.66522e−11 A10 = 2.80444e−13 A12 = −4.40753e−16
A14 = 2.14003e−19
22nd Surface
K = 0.00000e+00 A 4 = 2.47333e−05 A 6 = −1.08691e−07
A 8 = −3.67618e−09 A10 = 8.32902e−11 A12 = −5.61822e−13
30th Surface
K = 0.00000e+00 A 4 = 8.12166e−05 A 6 = −2.58919e−06
A 8 = 1.09833e−08 A10 = −9.31076e−11 A12 = −8.23007e−13
31st Surface
K = 0.00000e+00 A 4 = 1.52477e−04 A 6 = −1.68489e−06
A 8 = 4.19142e−09 A10 = −1.43820e−11 A12 = 8.41273e−14

VARIOUS DATA

| | |
|---|---|
| Focal Length | 10.16 |
| Fno | 4.08 |
| Half Angle of View (°) | 59.57 |
| Image Height | 17.30 |
| Overall Lens Length | 132.23 |
| BF | 12.30 |

IMAGE STABILIZING LENS UNIT DATA

| Starting Surface No. 32 | End Surface No. 33 | |
|---|---|---|
| Focal Length fis | 243.849 | mm |
| Correction Angle | 0.400° | |
| Tilt Component | 2.870° | |
| Rotation Center | −5.083 | mm |
| Sensor Shift Amount | −0.012 | mm |

### Numerical Example 4

UNIT: mm
SURFACE DATA

| Surface No. | r | d | nd | νd | Effective Diameter |
|---|---|---|---|---|---|
| 1* | 23.259 | 1.00 | 1.90366 | 31.3 | 32.80 |
| 2* | 10.108 | 7.81 | | | 24.46 |
| 3 | −644.086 | 4.50 | 1.51742 | 52.4 | 24.25 |
| 4 | −39.136 | 0.10 | | | 22.33 |
| 5 | −53.039 | 1.56 | 1.43875 | 94.7 | 21.11 |
| 6 | 16.368 | 15.63 | | | 16.93 |
| 7 | −41.585 | 2.50 | 1.72825 | 28.3 | 13.10 |
| 8 | −16.135 | 0.10 | | | 13.66 |
| 9 | −19.539 | 4.00 | 1.71300 | 53.9 | 13.65 |
| 10 | −12.006 | 2.50 | 1.90043 | 37.4 | 14.47 |
| 11 | −30.705 | 1.32 | | | 16.02 |
| 12 | 29.993 | 3.00 | 1.43875 | 94.7 | 17.02 |
| 13 | ∞ | 1.50 | | | 17.04 |
| 14 (SP) | ∞ | 5.84 | | | 17.05 |
| 15 | 22.733 | 2.50 | 1.90366 | 31.3 | 17.13 |
| 16 | 11.882 | 4.00 | 1.67270 | 32.1 | 15.72 |
| 17 | 35.536 | 0.96 | | | 15.34 |
| 18 | −456.472 | 2.98 | 1.71300 | 53.9 | 15.34 |
| 19 | −36.818 | 8.82 | | | 15.32 |
| 20 | 50.042 | 5.00 | 1.43875 | 94.7 | 15.45 |
| 21 | −15.362 | 0.66 | | | 16.09 |
| 22 | −15.704 | 1.00 | 2.00100 | 29.1 | 16.02 |
| 23 | 209.842 | 3.92 | 1.43875 | 94.7 | 17.80 |
| 24 | −23.852 | 0.10 | | | 19.18 |
| 25 | 112.940 | 2.89 | 1.43875 | 94.7 | 21.18 |
| 26 | −89.426 | 13.43 | | | 21.95 |
| 27* | −56.954 | 2.71 | 1.72916 | 54.7 | 27.62 |
| 28* | −36.143 | 13.06 | | | 28.79 |
| Image Plane | ∞ | | | | |

ASPHERIC DATA
1st Surface
K = −1.45747e+01 A 4 = 3.92487e−05 A 6 = −2.40389e−07
A 8 = 5.97203e−10 A10 = −4.58627e−13 A12 = −2.35685e−16
2nd Surface
K = −2.15988e+00 A 4 = 8.20950e−05 A 6 = 5.68006e−07
A 8 = −7.99187e−09 A10 = 3.61040e−11 A12 = −4.84023e−14
27th Surface
K = −1.44983e+00 A 4 = −1.68567e−04 A 6 = 1.16285e−06
A 8 = −9.54872e−09 A10 = 5.61320e−11 A12 = −1.11585e−13
28th Surface
K = −8.67627e−01 A 4 = −1.32741e−04 A 6 = 9.08901e−07
A 8 = −6.07306e−09 A10 = 3.01551e−11 A12 = −4.84268e−14

VARIOUS DATA

| | |
|---|---|
| Focal Length | 13.03 |
| Fno | 2.88 |
| Half Angle of View | 53.03 |
| Image Height | 17.31 |
| Overall Lens Length | 113.39 |
| BF | 13.06 |

IMAGE STABILIZING LENS UNIT DATA

| Starting Surface No. 27 | End Surface No. 28 | |
|---|---|---|
| Focal Length fis | 128.590 | mm |
| Correction Angle | 0.400° | |
| Tilt Component | 1.357° | |
| Rotation Center | 6.525 | mm |
| Sensor Shift Amount | −0.067 | mm |

### Numerical Example 5

UNIT: mm
SURFACE DATA

| Surface No. | r | d | nd | νd | Effective Diameter |
|---|---|---|---|---|---|
| 1* | 17.419 | 1.00 | 1.95375 | 32.3 | 37.71 |
| 2* | 8.543 | 14.77 | | | 26.37 |
| 3 | 222.236 | 4.50 | 1.63980 | 34.5 | 23.14 |
| 4 | −30.589 | 0.10 | | | 22.08 |
| 5 | −32.759 | 1.57 | 1.43875 | 94.7 | 21.11 |
| 6 | 25.121 | 8.89 | | | 17.30 |
| 7 | −37.042 | 1.91 | 1.73800 | 32.3 | 11.82 |
| 8 | −16.683 | 0.10 | | | 12.23 |
| 9 | −19.666 | 4.00 | 1.71700 | 47.9 | 12.23 |
| 10 | −11.780 | 2.44 | 1.88300 | 40.8 | 13.05 |
| 11 | −27.212 | 2.77 | | | 14.29 |
| 12 | 31.999 | 3.00 | 1.43875 | 94.7 | 15.22 |
| 13 | 248.027 | 2.61 | | | 15.20 |
| 14 (SP) | ∞ | 2.70 | | | 15.22 |
| 15 | 17.267 | 2.19 | 1.90366 | 31.3 | 15.26 |
| 16 | 12.987 | 4.00 | 1.67270 | 32.1 | 14.13 |
| 17 | 19.928 | 2.09 | | | 13.10 |
| 18 | 266.181 | 3.00 | 1.74400 | 44.8 | 12.98 |
| 19 | −31.296 | 0.55 | | | 12.79 |
| 20 | 31.557 | 4.20 | 1.45860 | 90.2 | 11.93 |
| 21 | −17.773 | 0.12 | | | 12.29 |
| 22 | −16.810 | 3.00 | 2.00100 | 29.1 | 12.30 |
| 23 | 23.317 | 5.00 | 1.49700 | 81.5 | 14.94 |
| 24 | −26.657 | 0.93 | | | 17.33 |
| 25 | 202.932 | 2.90 | 1.67270 | 32.1 | 20.53 |
| 26 | −44.178 | 11.94 | | | 21.33 |
| 27 | −25.556 | 1.00 | 1.80400 | 46.6 | 27.53 |
| 28 | −35.844 | 12.00 | | | 29.29 |
| Image Plane | ∞ | | | | |

ASPHERIC DATA
1st Surface
K = −9.58533e+00 A 4 = 5.29767e−05 A 6 = −2.92923e−07
A 8 = 7.25887e−10 A10 = −7.96589e−13 A12 = 2.13853e−16
2nd Surface
K = −1.92005e+00 A 4 = 1.14874e−04 A 6 = 6.81843e−07
A 8 = −8.35932e−09 A10 = 3.38475e−11 A12 = −4.31149e−14

VARIOUS DATA

| | |
|---|---|
| Focal Length | 13.30 |
| Fno | 2.88 |
| Half Angle of View (°) | 52.46 |
| Image Height | 17.31 |
| Overall Lens Length | 103.29 |
| BF | 12.00 |

IMAGE STABILIZING LENS UNIT DATA

| Starting Surface No. 27 | End Surface No. 28 | |
|---|---|---|
| Focal Length fis | −115.762 | mm |
| Correction Angle | 0.400° | |
| Tilt Component | 0.924° | |
| Rotation Center | 0.399 | mm |
| Sensor Shift Amount | −0.083 | mm |

### Numerical Example 6

UNIT: mm
SURFACE DATA

| Surface No. | r | d | nd | νd | Effective Diameter |
|---|---|---|---|---|---|
| 1* | 27.973 | 3.00 | 1.53775 | 74.7 | 42.16 |
| 2* | 13.640 | 10.58 | | | 28.93 |
| 3 | 29.473 | 1.00 | 1.43875 | 94.7 | 28.12 |
| 4 | 21.157 | 15.33 | | | 26.15 |
| 5 | −16.716 | 1.68 | 1.64000 | 60.1 | 20.27 |
| 6 | −16.735 | 4.78 | | | 20.59 |
| 7 | −35.167 | 3.00 | 1.80400 | 46.6 | 14.19 |
| 8 | −13.551 | 2.50 | 1.85025 | 30.1 | 13.76 |
| 9 | −30.783 | 9.29 | | | 13.87 |
| 10 | 122.124 | 2.50 | 1.48071 | 85.3 | 15.06 |
| 11 | −93.487 | 1.92 | | | 15.13 |
| 12 (SP) | ∞ | 1.95 | | | 15.08 |
| 13 | 17.961 | 1.21 | 1.85025 | 30.1 | 15.00 |
| 14 | 12.391 | 3.98 | 1.72047 | 34.7 | 14.23 |
| 15 | 66.142 | 0.63 | | | 13.49 |
| 16 | −118.656 | 1.68 | 1.70154 | 41.2 | 13.45 |
| 17 | −38.354 | 1.82 | | | 13.16 |
| 18 | 115.085 | 3.93 | 1.43875 | 94.7 | 11.47 |
| 19 | −17.038 | 0.14 | | | 9.99 |
| 20 | −15.867 | 2.25 | 1.91650 | 31.6 | 9.87 |
| 21 | −1123.755 | 2.37 | 1.48749 | 70.2 | 11.07 |
| 22 | −18.165 | 3.28 | | | 11.92 |
| 23* | −23.139 | 1.19 | 1.76634 | 35.8 | 13.78 |
| 24* | −1073.305 | 18.33 | | | 15.23 |
| Image Plane | ∞ | | | | |

ASPHERIC DATA
1st Surface
K = −7.32424e−01 A 4 = 6.57344e−05 A 6 = −1.68061e−07
A 8 = −1.92648e−11 A10 = 2.02544e−13 A12 = 1.27207e−17
2nd Surface
K = −1.84504e−01 A 4 = 8.61170e−05 A 6 = 2.11791e−07
A 8 = −3.91802e−09 A10 = 2.10138e−11 A12 = −6.21372e−14
23rd Surface
K = −3.19330e+00 A 4 = −8.61622e−05 A 6 = 8.32104e−07
A 8 = 7.45519e−10 A10 = −2.98491e−11 A12 = 9.23118e−14
24th Surface
K = 1.38857e+04 A 4 = 2.99195e−06 A 6 = 9.77729e−07
A 8 = −4.52650e−09 A10 = 3.60246e−11 A12 = −1.65951e−13

VARIOUS DATA

| | |
|---|---|
| Focal Length | 20.39 |
| Fno | 2.88 |
| Half Angle of View (°) | 42.13 |
| Image Height | 18.44 |
| Overall Lens Length | 98.32 |
| BF | 18.33 |

IMAGE STABILIZING LENS UNIT DATA

| Starting Surface No. 3 | End Surface No. 4 | |
|---|---|---|
| Focal Length fis | −177.403 | mm |
| Correction Angle | 0.400° | |
| Tilt Component | −0.263° | |
| Rotation Center | −3.274 | mm |
| Sensor Shift Amount | −0.138 | mm |

### Numerical Example 7

UNIT: mm
SURFACE DATA

| Surface No. | r | d | nd | νd | Effective Diameter |
|---|---|---|---|---|---|
| 1* | 16.366 | 1.86 | 2.00100 | 29.1 | 34.77 |
| 2* | 7.914 | 15.95 | | | 24.21 |
| 3 | 34.635 | 3.10 | 1.76200 | 40.1 | 17.39 |
| 4 | −61.266 | 0.58 | | | 16.34 |
| 5 | −33.105 | 1.00 | 1.43875 | 94.7 | 16.03 |
| 6 | 22.217 | 4.92 | | | 13.40 |
| 7 | 150.304 | 2.03 | 1.73800 | 32.3 | 10.33 |
| 8 | −19.965 | 0.32 | | | 10.49 |
| 9 | −18.510 | 1.66 | 1.72047 | 34.7 | 10.44 |
| 10 | −11.720 | 1.66 | 1.89190 | 37.1 | 10.61 |
| 11 | −28.336 | 0.31 | | | 11.13 |
| 12 | 14.958 | 2.42 | 1.49700 | 81.5 | 11.25 |
| 13 | 206.437 | 1.62 | | | 10.93 |
| 14 (SP) | ∞ | 1.52 | | | 10.45 |
| 15 | 20.327 | 1.00 | 1.92286 | 18.9 | 9.78 |
| 16 | 14.188 | 1.00 | 1.65160 | 58.5 | 9.31 |
| 17 | 13.740 | 0.74 | | | 8.96 |
| 18 | 146.258 | 1.50 | 1.90043 | 37.4 | 8.96 |
| 19 | −28.433 | 1.84 | | | 8.84 |
| 20 | 128.051 | 2.10 | 1.85033 | 42.7 | 9.26 |
| 21 | −19.213 | 0.33 | | | 10.04 |
| 22 | −13.946 | 1.00 | 1.92119 | 24.0 | 10.07 |
| 23 | 29.099 | 3.74 | 1.43875 | 94.7 | 11.83 |
| 24 | −22.498 | 0.87 | | | 14.23 |
| 25 | −24.730 | 1.00 | 1.91082 | 35.3 | 15.42 |
| 26 | −22.882 | 2.93 | | | 16.21 |
| 27 | −12.168 | 1.00 | 1.48071 | 85.3 | 17.31 |
| 28 | −15.845 | 12.00 | | | 19.37 |
| Image Plane | ∞ | | | | |

ASPHERIC DATA
1st Surface
K = −6.58353e+00 A 4 = 3.44671e−05 A 6 = −2.05340e−07
A 8 = 4.13739e−10 A10 = −1.50104e−13 A12 = −3.63103e−16
2nd Surface
K = −1.52060e+00 A 4 = 8.42355e−05 A 6 = 8.63489e−07
A 8 = −9.21611e−09 A10 = 3.17240e−11 A12 = −4.17083e−14

VARIOUS DATA

| | |
|---|---|
| Focal Length | 13.30 |
| Fno | 2.88 |
| Half Angle of View (°) | 52.46 |
| Image Height | 17.31 |
| Overall Lens Length | 70.00 |
| BF | 12.00 |

IMAGE STABILIZING LENS UNIT DATA

| Starting Surface No. 27 | End Surface No. 28 | |
|---|---|---|
| Focal Length fis | −119.668 | mm |
| Correction Angle | 0.400° | |
| Tilt Component | 1.511° | |
| Rotation Center | 5.984 | mm |
| Sensor Shift Amount | −0.058 | mm |

| | Numerical Example | | | | | | |
|---|---|---|---|---|---|---|---|
| Inequality | 1 | 2 | 3 | 4 | 5 | 6 | 7 |
| (1) | 17.551 | 11.054 | 23.994 | 9.870 | 8.706 | 8.700 | 9.000 |
| (2) | 2.954 | 2.120 | 4.650 | 3.999 | 3.206 | 2.010 | 1.471 |
| (3) | 0.350 | 0.173 | 0.500 | 0.501 | 0.030 | 0.161 | 0.450 |
| (4) | 0.036 | 0.017 | 0.013 | 0.024 | 0.010 | 0.010 | 0.014 |
| (5) | 1.182 | 0.821 | 1.210 | 1.003 | 0.902 | 0.899 | 0.902 |
| (6) | 0.025 | 0.008 | 0.007 | 0.021 | 0.009 | 0.006 | 0.009 |
| (7) | 1.699 | 0.863 | 1.703 | 1.328 | 1.302 | 0.904 | 1.302 |

### Image Pickup Apparatus

FIG. 34 illustrates a digital still camera as an image pickup apparatus having the optical system L0 according to any one of the above examples as an imaging optical system. Reference numeral 20 denotes a camera body, and reference numeral 21 denotes an imaging optical system including any of the optical systems L0 according to Examples 1 to 7. Reference numeral 22 denotes an image sensor such as a CCD sensor or CMOS sensor that is built into the camera body 20 and photoelectrically converts an optical image (object image) formed by the imaging optical system 21, i.e., captures an object through the imaging optical system 21. Reference numeral 23 denotes a recorder configured to record image data generated by processing an imaging signal from the image sensor 22, and reference numeral 24 denotes a rear display unit configured to display image data.

The camera body 20 performs image processing to shift the image sensor 22 or shift the cut-out area from the image data as an image stabilizing operation according to the camera shake detected by an unillustrated shake sensor. During this image stabilizing operation, the camera body 20 rotates the image stabilizing lens unit LA in the optical system L0.

Using the optical system L0 according to each example can provide high-quality image data in which image blur is well corrected from the central area to the peripheral areas, while the optical system L0 has a reduced size.

The image pickup apparatus may be a single-lens reflex camera with a quick-turn mirror, or a mirrorless camera without a quick-turn mirror.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide an optical system capable of satisfactorily correcting image blurs from both the central area and the peripheral area of an image, in combination with the image stabilizing operation of the image pickup apparatus.

This application claims priority to Japanese Patent Application No. 2024-074224, which was filed on May 1, 2024, and which is hereby incorporated by reference herein in its entirety.

What is claimed is:

1. An optical system for use with an image pickup apparatus configured to perform an image stabilizing operation by moving an image sensor configured to image an object or by moving a cut-out area in an image generated using a signal from the image sensor, the optical system comprising:
an image stabilizing lens unit rotatable so as to tilt relative to an optical axis of the optical system; and
at least one negative lens.

2. The optical system according to claim 1, wherein the image stabilizing lens unit includes one single lens or one cemented lens.

3. The optical system according to claim 1, wherein the following inequality is satisfied:
$$8.45 \leq \vert fis \vert / f \leq 30.00$$
where fis is a focal length of the image stabilizing lens unit, and f is a focal length of the optical system.

4. The optical system according to claim 1, further comprising an aperture stop,
wherein the following inequality is satisfied:
$$1.3 \leq \vert tis \vert / f \leq 6.0$$
where tis is a distance on the optical axis from the aperture stop to a lens surface closest to the aperture stop of the image stabilizing lens unit, and f is a focal length of the optical system.

5. The optical system according to claim 1, wherein the following inequality is satisfied:
$$0 < \vert dis \vert / f \leq 0.51$$
where dis is a distance on the optical axis from a lens surface closest to the object of the image stabilizing lens unit to a rotation center of the image stabilizing lens unit, and fis a focal length of the optical system.

6. The optical system according to claim 1, wherein the following inequality is satisfied:
$$0 < Da / D \leq 0.06$$
where Da is a length on the optical axis from a lens surface closest to the object of the image stabilizing lens unit to a lens surface closest to an image plane of the image stabilizing lens unit, and D is a length on the optical axis from a lens surface closest to the object of the optical system to the image plane.

7. The optical system according to claim 1, wherein the following inequality is satisfied:
$$0.75 \leq Dbf / f \leq 1.30$$
where Dbf is a length on the optical axis from a lens surface closest to an image plane of the optical system to the image plane, and f is a focal length of the optical system.

8. The optical system according to claim 1, wherein the following inequality is satisfied:
$$0 < Da / \vert fis \vert \leq 0.03$$
where Da is a length from a lens surface closest to the object of the image stabilizing lens unit to a lens surface closest to an image plane of the image stabilizing lens unit, and fis is a focal length of the image stabilizing lens unit.

9. The optical system according to claim 1, wherein the following inequality is satisfied:
$$0. 8 \leq ymax / f \leq 1.8$$
where ymax is a maximum image height of the optical system, and f is a focal length of the optical system.

10. The optical system according to claim 1, wherein the optical system includes, in order from an object side to an image side, a first lens unit, a second lens unit as the image stabilizing lens unit, an aperture stop, and a third lens unit.

11. The optical system according to claim 1, wherein the optical system includes, in order from an object side to an image side, a first lens unit, an aperture stop, a second lens unit, and a third lens unit as the image stabilizing lens unit.

12. The optical system according to claim 1, wherein the optical system includes, in order from an object side to an image side, a first lens unit, a second lens unit including an aperture stop closest to the object, and a third lens unit as the image stabilizing lens unit.

13. The optical system according to claim 1, wherein the optical system includes, in order from an object side to an image side, a first lens unit, a second lens unit as the image stabilizing lens unit, a third lens unit, an aperture stop, and a fourth lens unit.

14. A lens apparatus attachable to and detachable from an image pickup apparatus, the lens apparatus comprising:
the optical system according to claim 1; and
an actuator configured to rotate the image stabilizing lens unit during an image stabilizing operation in the image pickup apparatus.

15. An image pickup apparatus comprising:
the optical system according to claim 1 integrated with or detachably attached to the image pickup apparatus; and
an actuator configured to rotate the image stabilizing lens unit during an image stabilizing operation.

16. An image pickup apparatus comprising:
the optical system according to claim 1 integrated with or detachably attached to the image pickup apparatus; and
an image processing unit configured to correct distortion in an image generated using a signal from the image sensor by using distortion correction data corresponding to the optical system.
